(19) United States
(12) Patent Application Publication
(10) Pub. No.: US 2018/0348029 A1
(43) Pub. Date: Dec. 6, 2018

(54) APPARATUS FOR ESTIMATING THE VOLUME OF FLUID FLOWING IN A PIPE

(71) Applicant: OXEAU INVEST, Bordeaux (FR)

(72) Inventor: Jacques Le Floc'h, St Romain (FR)

(21) Appl. No.: 15/774,637

(22) PCT Filed: Nov. 8, 2016
(86) PCT No.: PCT/FR2016/052882

§ 371 Date: May 9, 2018

(30) Foreign Application Priority Data
Nov. 10, 2015 (FR) 1560759
Jun. 24, 2016 (FR) 1655930

(51) Int. Cl. G01F 1/66

(52) U.S. Cl. CPC G01F 1/665; G01F 1/662

(57) ABSTRACT

Equipment for estimating the volume of fluid flowing in a pipe, the equipment comprises means for generating vibrations in the pipe and means for actuating the means generating the vibrations, the actuation means being mounted so as to move on a pin passing diametrically through the pipe, between a position in which the actuation means come into contact with a wall, thus actuating the means generating the vibrations, and a position in which the actuation means are separated from the wall.

### BACKGROUND OF THE INVENTION

The present invention relates to the measurement of the volume of water flowing in a pipe, in particular in a drinking-water supply pipe. A flowmeter is used for this purpose, which is inserted on the water-flow circuit.

Very many varieties of flowmeter are known, using technologies such as:

measuring the speed of the fluid, for example a flowmeter with turbine, piston or rotors,

measuring the interaction of the fluid with an audible signal, for example an ultrasound flowmeter,

measuring the electrical interaction, for example an ionic flowmeter or a current meter,

measuring the variations in pressure caused by Karman vortices by a vortex-effect flowmeter,

an electromagnetic flowmeter measures the response of a conductive fluid to a magnetic field,

measuring the loss of head (pressure drop) or differential pressure between an upstream reference and a downstream reference, by means of a vacuum-generating organ such as an orifice plate, a nozzle (as in the case of a Venturi-tube flowmeter) or a diaphragm.

### SUMMARY OF THE INVENTION

In order to remedy these drawbacks, the invention relates, according to its most general acceptance, to equipment for estimating the volume of fluid flowing in a pipe, characterised in that it comprises at least one bracket suspended by a pin rigidly connected to the wall of the pipe, and able to move between an unstable position in which a portion of the bracket engages with the wall, and a position in which said portion is separated from the wall, as well as a sensor for detecting the impact of said bracket on said wall.

This mechanical solution makes it possible to count a precise volume measurement of fluid in a duct.

It is a case of producing an impact that constitutes a clear sharp signal. Once the signal is produced, it can be detected whatever the electronic sensor that then measures it. This solution makes it possible to precisely measure quantities of volumes for a flow. For a given cross-section of the mechanism, as well as with regard to its other features, fin or bracket, the match is established by a nomogram of the volume proportional to the number of impacts noted, captured and measured by counting the number of impacts in a given time for a given cross-section of duct for a given volume moved.

Preferably, said bracket supported by a horizontal pin has a mass downstream of said pin greater than the mass upstream of said pin.

According to a variant, said bracket has a forked downstream end.

According to another variant, said bracket has a twisted shape.

According to a third variant, the equipment further comprises a rotary propeller placed in the fluid flow, having at least one blade interacting with said bracket able to move between a position in which it is pushed by said region of the blade and a position in which it comes into contact with the wall of the pipe.

The invention also relates to a system for estimating the volume of fluid flowing in a pipe, characterised in that it consists of equipment comprising at least one bracket suspended by a pin secured to the wall of the pipe, and able to move between an unstable position in which a portion of the bracket comes in contact with the wall, and a position in which said portion is separated from the wall, as well as an audible sensor fixed to the external wall of said pipe, delivering an electrical signal to an electronic circuit.

Advantageously, said electronic circuit comprises means for analysing firstly the audible signals produced by the impacts of the bracket on the wall of the pipe and secondly the audible signature produced by the change in state of fluid-consumption equipment of the installation.

According to a variant, the system is configured to allow fitting on an existing installation by unscrewing a coupling on the conduit and inserting said system.

Advantageously, the system is configured to allow adaptation to the cross-section of a duct.

The invention also relates, in general terms, to equipment for estimating the volume of fluid flowing in a pipe, equipment for estimating the volume of fluid flowing in a pipe, characterised in that it comprises means for generating vibrations in the pipe and means for actuating the means generating the vibrations, said actuation means being mounted so as to be able to move on a pin passing diametrically through the pipe, between a position in which the actuation means come into contact with a wall, thus actuating the means generating the vibrations, and a position in which the actuation means are separated from said wall.

This can repeat the features previously described, independently of one another or in combination. More particularly, provision may be made for:

the means generating the vibrations to comprise at least one bracket suspended by a pin secured to the wall of the pipe, and able to move between an unstable position where a portion of the bracket comes into contact with the wall, and a position where said portion is separated from the wall,

said bracket to be supported by a horizontal pin, and to have a mass downstream of said pin greater than the mass upstream of said pin,

said bracket to have a forked downstream end and/or a twisted shape,

it to comprise a rotary propeller placed in the fluid flow, having a least one blade interacting with said bracket able to move between a position in which it is pushed by said region of the blade and a position in which it comes into contact with the wall of the pipe, said propeller constituting the means of actuating said bracket,

it to have a body comprising a first portion defining an inlet conduit and a second portion defining a cavity open at the outlet end of the tubular body, a propeller being mounted so as to be able to rotate freely on a pin passing diametrically through the cavity, the propeller having at least one blade interacting with an arrangement of balls housed in a channel provided in the wall of the inlet conduit, the arrangement of balls and said propeller constituting respectively the means generating the vibrations and the actuation means,

the means for generating the vibrations and the actuation means to form a single piece.

### BRIEF DESCRIPTION OF THE DRAWINGS

The invention will be understood better from a reading of the following description, referring to non-limitative example embodiments illustrated by the accompanying drawings, in which:

FIGS. 1 and 2 show views respectively in longitudinal section and in cutaway of equipment according to the invention

FIG. 3 shows a view in longitudinal section of a pipe with a first variant embodiment

FIG. 4 shows a three-quarter front view of a pipe with a second variant embodiment

FIG. 5 shows a view in longitudinal section of a pipe with a third variant embodiment

FIG. 6 shows a view in longitudinal section of equipment according to another embodiment

FIG. 7 shows a schematic view of the equipment of FIG. 1, the equipment being shown without the means generating the vibrations and the associated actuation means

FIG. 8 shows a view in perspective along the axis AA of the equipment of FIG. 7.

### DETAILED DESCRIPTION

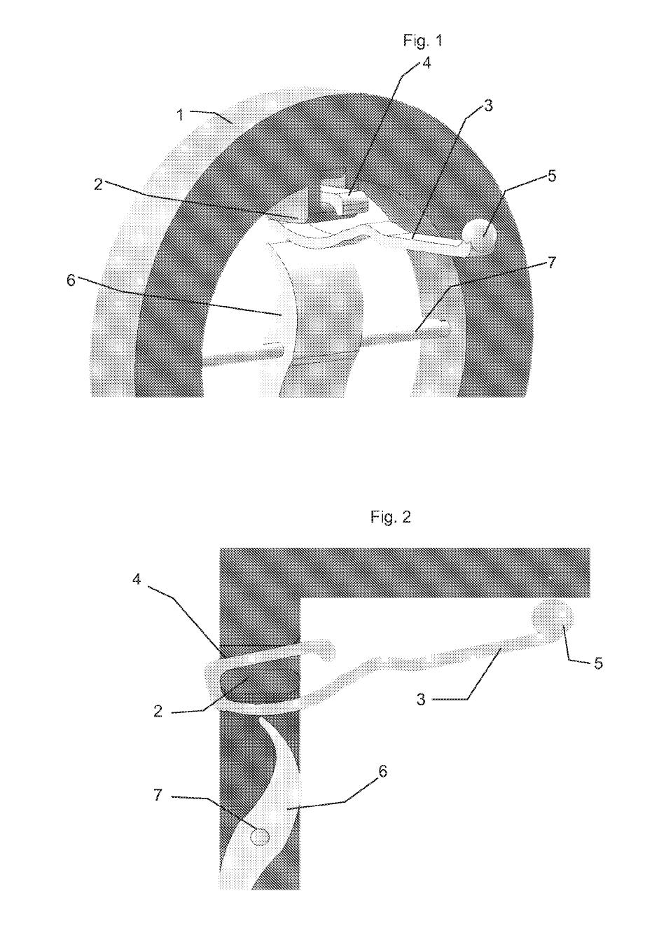

The invention relates to a mechanical solution that allows metering (therefore a volume) using a complementary electroacoustic sensor. In general terms, the invention illustrated in FIGS. 1 to 5 uses an asymmetric element formed by an audible or vibratory bracket striking the wall for electronic interception of the flow of a fluid (water, etc.) in a pipe.

The frequency of the impacts of the bracket on the internal wall of the pipe makes it possible to estimate the quantities of fluid passing through the pipe through the electronic capture of the signal produced precisely by the beat: in fact this solution becomes a sensor.

The equipment is housed in the tube at a coupling, which does not require any joint, which is not more than 3 mm in thickness, and which therefore in no way interferes with the existing installation.

With the signal of the bracket, it is possible to know in the period, the number of strikes, the variation in the strikes and the intensity of the strike by virtue of the measuring system used, for example a piezoelectric or acoustic sensor.

FIGS. 1 and 2 show a first example embodiment.

The equipment is formed by a tubular element (1) having a cross-section identical to that of the fluid-flow pipe in which it is inserted. This tubular element (1) has a clevis (2) for suspension of a bracket (3), having in the example described a curved part (4) coming into abutment on the clevis (2) and a free end (5) coming into contact with the wall of the pipe when the bracket (3) is struck by a blade (6) mounted on a pin (7) passing diametrically and horizontally through the tubular element (1). In this embodiment, the bracket (3) constitutes the means for generating the vibrations, the propeller (6) constituting the means of actuating said bracket (3).

The functioning is as follows: the circulation of fluid in the pipe causes the rotation of the blade (6), the ends of which push the bracket (3). Its free end (5) strikes the internal wall of the pipe, which causes vibrations detected by a piezoelectric or acoustic sensor fixed to the pipe. Analysis of the signals detected makes it possible to calculate the volume of fluid flowing in the pipe.

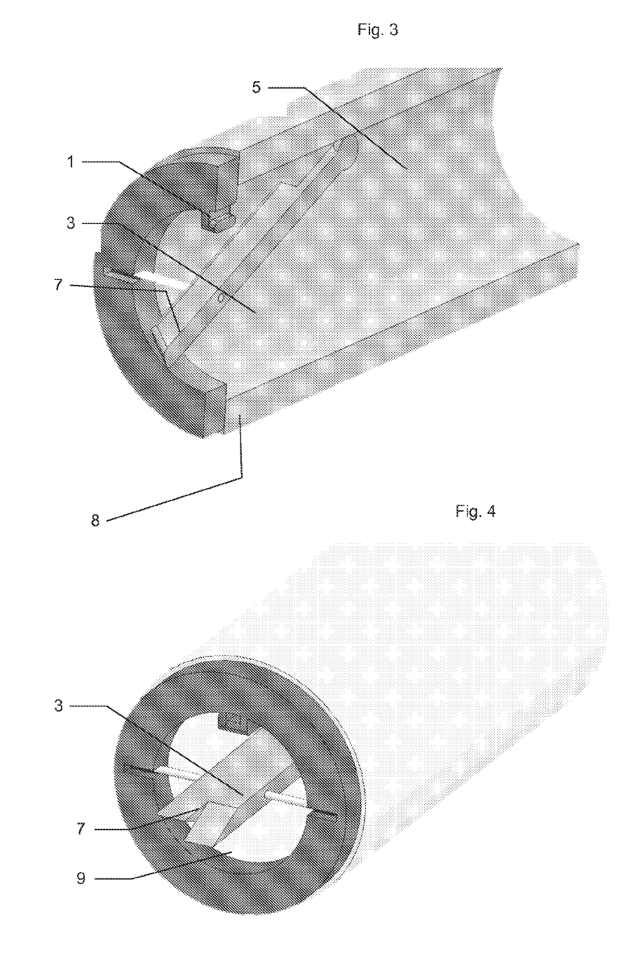

FIG. 3 shows a variant embodiment where the bracket (3) has a twisted shape, so that a leading edge (8) interacts with the fluid flowing in the pipe in order to move the bracket (3) between an idle position and a position in which the end (5) strikes the wall of the pipe.

FIG. 4 shows a variant embodiment where an upstream end (9) opposite to the free end (5) coming into contact with the wall of the pipe is forked, in order to interact with the flowing fluid.

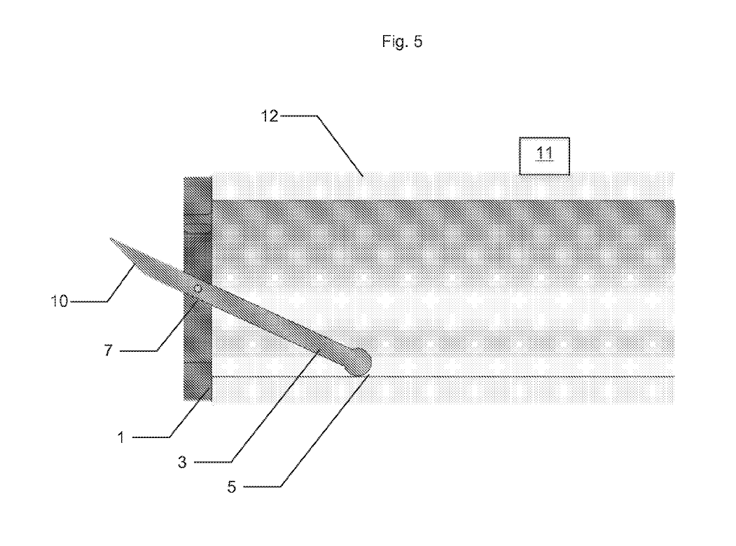

FIG. 5 shows another variant where the upstream end (10) is in a bevel shape.

In the embodiments illustrated in FIGS. 3 to 5, the means for generating the vibrations are formed by the end (5) of the bracket (3). The means for generating the vibrations and the actuation means (body of the bracket (3)) thus form a single piece.

A piezoelectric or acoustic sensor (11) fixed to the pipe (12) receives and then supplies an electrical signal that is a function of the number of pulses and/or of the vibrations transmitted by the wall of the pipe.

These vibrations result from two phenomena of distinct natures:

the impacts of the end (5) of the bracket (3) on the wall of the pipe,

the microdisturbances produced by the change in the state of a fluid-consumption station upstream or downstream of the sensor (11), for example the opening or closing of a tap, a water flush or a valve.

These signals are the subject of a data analysis, for example of the spectral data, in order to separate two spectra corresponding one to the low frequencies and high amplitude and the other to higher frequencies and low amplitude.

The initial calibration takes into account the variables necessary for the volumetric measurement: diameter of the tube, diameter of the object, number of blades of a propeller, size and weight if a bracket, etc. The calibration curve is determined for example by a measurement carried out by a volume-measuring appliance making it possible to “calibrate” and reference the result of each mechanism corresponding to the cross-section of the duct to which it corresponds in order to make its volumetric measurements. This measurement is done in the laboratory in order to standardise the parts of the mechanism in their dimensions, materials, etc.

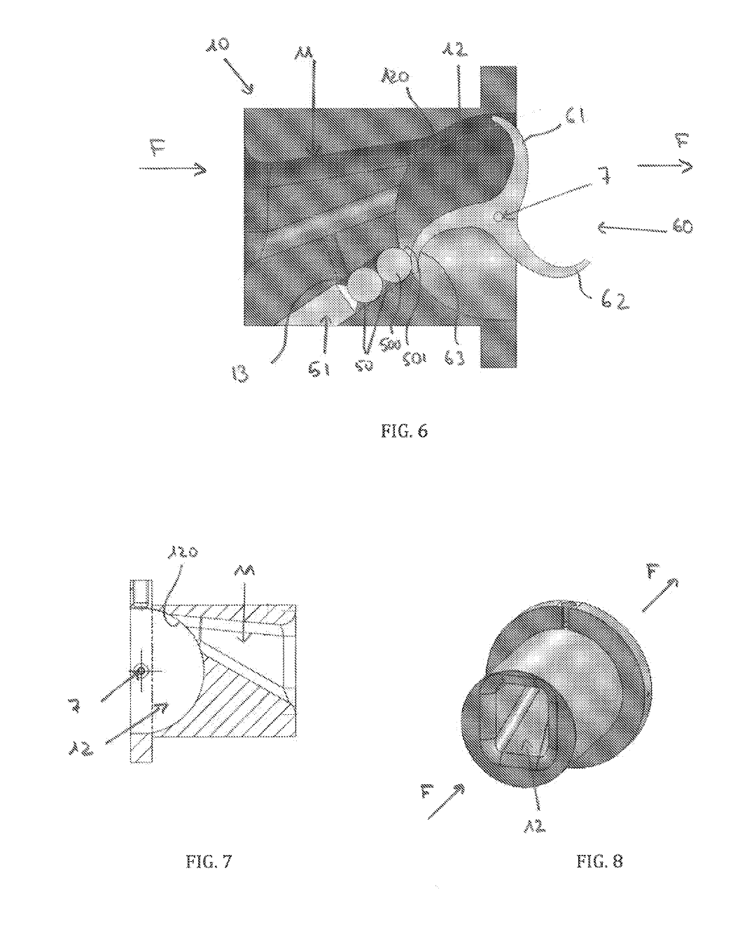

FIGS. 6 to 8 show another embodiment of the equipment according to the invention based on the same operating principle as the equipment illustrated in FIGS. 1 to 5.

In this embodiment the equipment has a tubular body (10) having end openings. The tubular body (10) comprises a first part defining an inlet conduit (11) and a second part defining a cavity (12) open at the outlet end of the tubular body. As illustrated in FIGS. 6 and 7, the inlet conduit is arranged to define a convergent nozzle (hereinafter referenced (11)), the latter communicating directly at its outlet with the cavity (12). The terms “inlet” and “outlet” are determined in accordance with the direction of flow of the fluid, which is represented by the arrow referenced F.

A propeller (60) is mounted so as to rotate freely on a pin (7) passing diametrically through the cavity, at the outlet end of the tubular body. In the embodiment illustrated, the propeller (60) is shown with three blades (61, 62, 63). As in the embodiment illustrated in FIG. 1, the propeller (60), and more specifically the blades (61, 62, 63), constitute means for actuating the means generating the vibrations, in this case balls (50) housed in a channel (13) formed in the wall of the nozzle (11) (FIG. 6). It is obvious that a propeller may be provided comprising a different number of blades, including a single blade, without departing from the scope of the invention.

As indicated previously, the nozzle (11) has a wall provided with a channel (13) housing means generating vibrations. Said channel (13), which is rectilinear, is arranged to emerge in the cavity (12) of the tubular body (10), and to be adjacent to the wall of the fluid-flow pipe when the equipment is in place on said flow pipe in which it is inserted. Balls (50), in the example illustrated two, preferably with identical cross-sections and natures (i.e. material), are disposed in the channel (13), locked therein by means of a part forming a stop (53). Said part is preferably produced in the same material as that of the balls. The part forming a stop (13) and the balls (50) are arranged so that the end ball (500) has a ball portion (501) slightly projecting beyond the wall (120) of the cavity. A complementary channel (53) extending between the nozzle (11) and the channel (13) housing the balls is also provided in order to establish an opposition pressure on the balls in order to force them to return towards the blades.

The part forming a stop (51) and the balls constitute, in this embodiment, the means for generating the vibrations in response to the impact transmitted by the blades of the propeller as they pass and come into contact with the portion (501) of the ball (500) projecting into the cavity (12). As will be understood, the vibrations are transmitted by the end ball (500) to the wall of the fluid-flow pipe, via the part forming a stop (51) and the second ball in response to the impact given by one of the blades of the propeller (60) on the end ball (500), according to the principle of Newton's cradle balance.

As before, the signals relating to the vibrations are recorded with a piezoelectric or acoustic sensor fixed to the fluid-flow pipe in order to transform them into electrical signals that are a function of the number of pulses and/or vibrations transmitted by the wall of the pipe. These signals are then the subject of data analysis, for example spectral data, in order to separate two spectra corresponding in one case to low frequencies and high amplitude and in the other case to high frequencies and low amplitude.

The advantage of the equipment according to the invention is the non-intrusive character of the fitting in a pipe. This is because the equipment is slid into a pipe at a coupling after simple unscrewing of the latter. No physical action on the tubes (connection, cuts, adaptation of diameter, etc.) is therefore necessary.

1. Equipment for estimating the volume of fluid flowing in a pipe, the equipment comprises means for generating vibrations in the pipe and means for actuating the means generating the vibrations, said actuation means being mounted so as to move on a pin passing diametrically through the pipe, between a position in which the actuation means come into contact with a wall, thus actuating the means generating the vibrations, and a position in which the actuation means are separated from said wall.

2. The equipment for estimating the volume of fluid flowing in a pipe according to claim 1, wherein the means generating the vibrations comprise at least one bracket suspended by a pin secured to the wall of the pipe, and configured to move between an unstable position in which a portion of the bracket comes into contact with the wall, and a position in which said portion is separated from the wall.

3. The equipment for estimating the volume of fluid flowing in a pipe according to claim 2, wherein said bracket is supported by a horizontal pin, and has a mass downstream of said pin greater than the mass upstream of said pin.

4. The equipment for estimating the volume of fluid flowing in a pipe according to claim 3, wherein said bracket has a forked downstream end.

5. The equipment for estimating the volume of fluid flowing in a pipe according to claim 4, wherein said bracket has a twisted shape.

6. The equipment for estimating the volume of fluid flowing in a pipe according to claim 5, further comprising a rotary propeller placed in the flow of fluid, having at least one blade interacting with said bracket able to move between a position in which the propeller is pushed by said region of the blade and a position in which the propeller comes into contact with the wall of the pipe, said propeller constituting the means for actuating said bracket.

7. The equipment for estimating the volume of fluid flowing in a pipe according to claim 1, wherein the equipment has a body comprising a first portion defining an inlet conduit and a second portion defining a cavity open at the outlet end of the tubular body, a propeller being mounted configured to rotate freely on a pin passing diametrically through the cavity, the propeller having at least one blade interacting with an arrangement of balls housed in a channel provided in the wall of the inlet conduit, the arrangement of balls and said propeller constituting respectively the means generating the vibrations and the actuation means.

8. The equipment for estimating the volume of fluid flowing in a pipe according claim 5, wherein the means for generating the vibrations and the actuation means form a single piece.

9. The equipment for estimating the volume of fluid flowing in a pipe according to claim 8, wherein the equipment is configured to allow fitting on an existing installation by unscrewing a coupling on the conduit and inserting said system.

10. The equipment for estimating the volume of fluid flowing in a pipe according to claim 9, wherein the equipment is configured to allow adaptation to the cross-section of a duct.
